(19) United States
(12) Patent Application Publication
(10) Pub. No.: US 2005/0182664 A1
(43) Pub. Date: Aug. 18, 2005

(54) Method of monitoring patient participation in a clinical study

(76) Inventors: Klaus Abraham-Fuchs, Erlangen (DE); Gudrun Zahlmann, Neumarkt (DE); Rainer Kuth, Herzogenaurach (DE); Eva Rumpel, Erlangen (DE); Siegfried Schneider, Erlangen (DE); Markus Schmidt, Nuernberg (DE); Horst Schreiner, Fuerth (DE)

Correspondence Address: HARNESS, DICKEY & PIERCE, P.L.C., P.O.BOX 8910, RESTON, VA, 20195, US

(21) Appl. No.: 10/975,056

(22) Filed: Oct. 28, 2004

Related U.S. Application Data
(60) Provisional application No. 60/545,170, filed on Feb. 18, 2004.

(51) Int. Cl. G06F 17/60

(52) U.S. Cl. 705/3

(57) ABSTRACT

A method is proposed for monitoring participation of a patient in at least one clinical trial. The method includes collecting data regarding at least one clinical trial for the patient. Using a computer device, the collected data is then compared to at least one threshold. Finally, the patient is rewarded upon the collected data at least meeting at least one threshold.

The present application hereby claims priority under 35 U.S.C. §119 on U.S. provisional patent application No. 60/545,170 filed Feb. 18, 2004, the entire contents of which are hereby incorporated herein by reference.

### FIELD OF THE INVENTION

The present invention is generally related to the field of clinical studies.

### BACKGROUND OF THE INVENTION

The framework for traditional business models for clinical studies has been rather stable over the last few decades. In such a business model, a sponsor (such as a pharmaceutical company which has developed a new drug, for example) paid all participants which performed in the study. At a minimum, these included participating patients and a medical doctor (an investigator) in charge of supervising the patients. In many cases, an investigation or clinical trial site (e.g., a hospital) was additionally included, where one or more investigators was employed.

So called contract research organizations (CROs) further established their services in the workflow chain of clinical studies, in between the sponsor on one end, and the investigator and patients on the other. The CRO often took over the complete management of the clinical study, including all necessary services including, for example, development of study protocol, recruiting patients and investigators and/or investigation sites, contracting the participants, supervising the conductance of the study, collecting and evaluating data, channeling the payment from the sponsor to the participants, etc. Of course, for such services, the CRO received a substantial part of the aforementioned payment for their own services.

When recruiting the patients, the CRO, or even the sponsor, tended to use and still uses crude methods wherein prospective patients fill out forms and are screened as candidates for clinical studies. The data utilized is normally that obtained from the patient himself or herself. Regarding the investigator or investigator/clinical trial site chosen to conduct/monitor/etc. the study, information previously obtained by the sponsor or CRO can be used. However, this is often a slow process which often does not produce an ideal patient, investigator or investigator/clinical trial site.

FIG. 1 illustrates a typical traditional cash flow system for use in connection with clinical studies. Initially, a sponsor 100 (such as a drug manufacturer, for example) defines the study requirements or criteria (study parameters, study protocol, etc.) for the particular clinical study in question. A CRO 120 may then be employed to manage the study, noting that the CRO 120 may develop the study requirements or criteria of the clinical study or may assist therein. The CRO may also assist in recruiting patients for the study, as well as selecting an appropriate investigator/investigators and appropriate clinical trial site(s). If a CRO is involved, the CRO is paid by the sponsor 100. The CRO then manages the study and then pays others involved in the study including investigators 130, patients 140, and potentially investigation or clinical trial sites such as hospitals, for example (not shown).

It was often difficult to maintain patients, for example, for the entire length of the study, or even through important portions of the study. For whatever reasons, the patients were and still are often not part of the entire clinical trial. However, the compliance of study objects in clinical trials directly affects the final size of the study and therefore the quality thereof, and sometimes the accomplishments of the study. After identifying and recruiting the patients, retaining them throughout the complete clinical trial was and still is a challenging task and required high motivation from the patients and/or the investigator. In the past, the only motivation provided was some type of payment or medical benefit.

### SUMMARY OF THE INVENTION

The present inventors have recognized problems with the traditional clinical study model, and an object of an embodiment of the present application is to improve on the traditional clinical study model, and thus improve the clinical study or clinical study process. One specific object involves improving incentives for patients of a clinical study. In one embodiment, this can include for example, a method of monitoring participation of a patient in at least one clinical trial. This can include collecting data regarding at least one clinical trial for the patient; comparing, using a computer device, the collected data to at least one threshold; and rewarding the patient upon the collected data at least meeting at least one threshold. Further, the collected data may be compared to a plurality of thresholds and the patient may be rewarded each time the collected data exceeds one of the plurality of thresholds. The present inventors have recognized these and other needs for improving a clinical study.

Further, in another embodiment for improving incentives for patients, the method can include a method of monitoring participation of a patient in at least one clinical trial. Such a method can include collecting data regarding at least one clinical trial for the patient; determining, using a computer device, whether or not the patient has complied with at least one criterion of the at least one clinical trial, from the collected data; and rewarding the patient upon determining that the patient has complied with at least one criterion of the at least one clinical trial.

Further, in another embodiment for improving incentives for patients, the method can include a method of monitoring participation of a patient in at least one clinical trial. Such a method can include collecting data regarding at least one clinical trial for the patient; determining, using a computer device, whether or not the patient has complied with at least one criterion of the at least one clinical trial; and indicating that the patient is entitled to compensation upon determining that the patient has complied with at least one criterion of the at least one clinical trial.

Further, in another embodiment, an apparatus for monitoring participation of a patient in at least one clinical trial can include at least one device for collecting data regarding at least one clinical trial for the patient from an external device and for comparing the collected data to at least one threshold. Further, it can include a device for rewarding the patient upon the collected data at least meeting at least one threshold.

Still further, in yet another embodiment, an apparatus for monitoring participation of a patient in at least one clinical trial can include at least one device for collecting data regarding at least one clinical trial for the patient from at least one external device and for determining whether or not the patient has complied with at least one criterion of the at least one clinical trial, from the collected data. Further, it can include a device for rewarding the patient upon determining that the patient has complied with at least one criterion of the at least one clinical trial.

Finally, in still another embodiment, an apparatus for monitoring participation of a patient in at least one clinical trial can include at least one device for collecting data regarding at least one clinical trial for the patient from at least one external device and for determining whether or not the patient has complied with at least one criterion of the at least one clinical trial. Further, it can include a device for indicating that the patient is entitled to compensation upon determining that the patient has complied with at least one criterion of the at least one clinical trial.

Other embodiments of the present application may include devices/systems for implementing any of the aforementioned methods, programs adapted to perform any of the aforementioned methods when executed on a computer device, and/or computer readable mediums storing any of the aforementioned programs.

For a full understanding of the nature and advantages of the various aspects of the invention, reference should be made to the detailed description of exemplary embodiments taken in conjunction with the accompany drawings. The detailed description provides only exemplary embodiments of the invention and thus, the claims of the present invention should not be limited as such.

### BRIEF DESCRIPTION OF THE DRAWINGS

The present invention will become more fully understood from the detailed description of preferred exemplary embodiments given hereinbelow and the accompanying drawings, which are given by way of illustration only and are thus not limitive of the present invention, and wherein:

FIG. 1 illustrates a typical traditional model for use in clinical studies;

FIG. 2 is an example of an aspect of an embodiment of the present application illustrating the analytical device and its connection to various databases and other equipment; and

FIG. 3 includes an exemplary embodiment of milestone achievement.

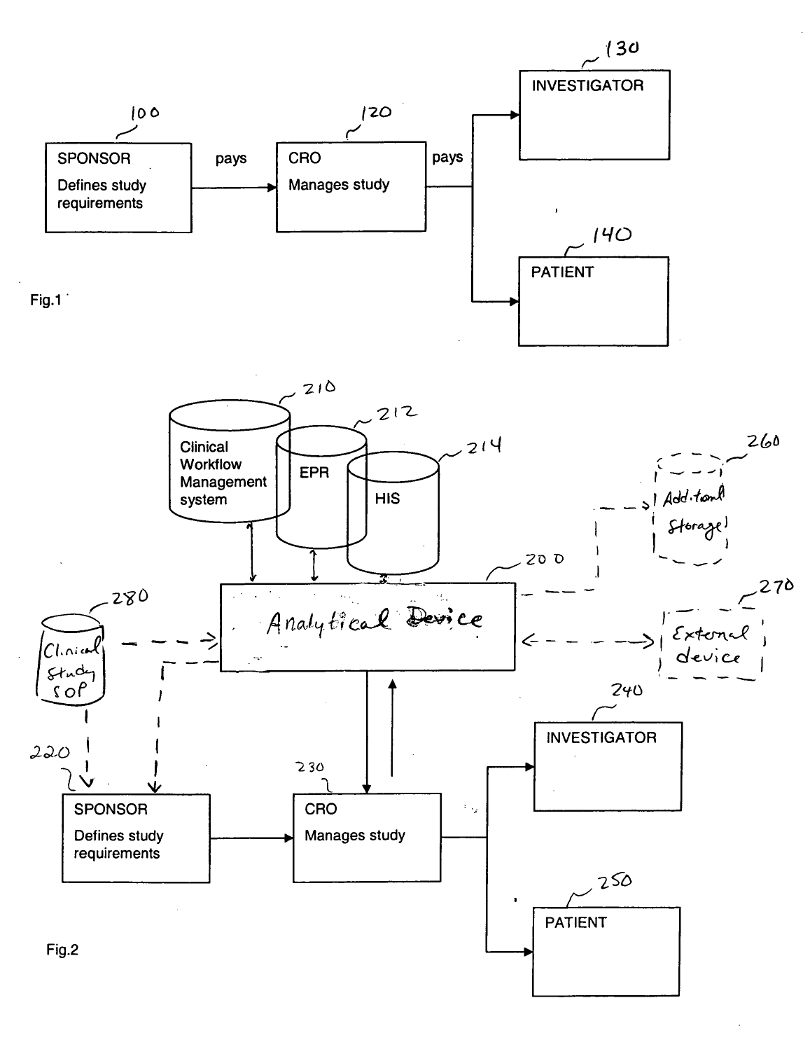

### DETAILED DESCRIPTION OF THE EXEMPLARY EMBODIMENTS OF THE PRESENT APPLICATION

In one embodiment, the present invention is directed to an improvement on the traditional clinical study model, and thus an improvement of the clinical study or clinical study process. Specifically, in one embodiment, the present invention is directed to improving incentives for patients of a clinical study. This can include for example, a method of monitoring participation of a patient in at least one clinical trial. In such a method, data is collected from at least one clinical trial for the patient. Thereafter, the collected data is compared, using a computer device (a device including a processor for example), to at least one threshold. The threshold can involve, for example, criteria for a clinical study including aspects defined in a clinical study protocol, target performance parameters of the clinical study, etc. The threshold can define acts/milestones/deadlines/etc. for performing/complying with aspects of the study. Finally, the patient may be rewarded upon the collected data at least meeting at least one threshold. The collected data may further be compared to a plurality of thresholds and the patient may be rewarded each time the collected data exceeds one of the plurality of thresholds (e.g. when milestones of the study are met). As such, the patient may be incentivized to continue participation in the study.

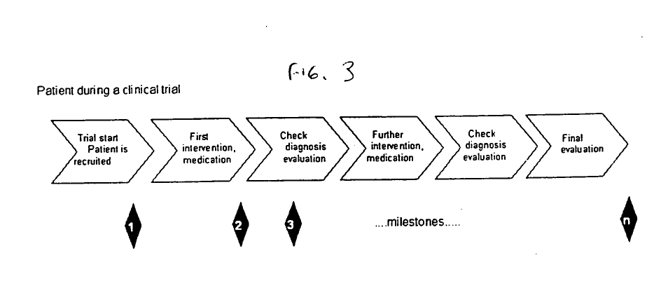

The criteria/thresholds/acts/milestones/deadlines/etc. for performing/complying with aspects of the study and clinical data may be obtained from the sponsor 220 and/or the CRO 230; and patient data may be obtained from existing clinical IT infrastructure including, but not limited to any of the clinical workflow management system 210, electronic patient records (EPR) 212, hospital information systems (HIS) 214 (or any other type of clinical IT infrastructure and/or database) as shown in FIG. 2. The collected data may be compared using a computer device, including but not limited to analytical device 200 (a device including a processor for example), to at least one threshold (which can be an act/milestone/deadline/etc.). Thereafter, the patient may be rewarded upon the collected data at least meeting at least one threshold, wherein the CRO 230 (and/or the sponsor 220) may then be notified and can reward the patient 250 (and/or the investigator 240). Such a reward may be directly given thereto, accumulated, stored and tracked in association with the patient/investigator, etc.

Clinical data can include data stored in a database of existing clinical IT infrastructure, such as an electronic healthcare database, for example. This can include, but is not limited to at least one of a database with electronic patient records, a database of clinical workflow management system, information from a hospital IT system (financial or clinical), information from a laboratory or radiology information system, information from a picture archiving and communication system (PACS), information from a physician's IT system, for example, etc.

As shown in FIG. 2 of the present application, an analytical device 200 has been developed. This analytical device 200 can be a type of computer device/processor and/or server which is networked or otherwise has access to clinical IT infrastructure and which is further networked to, or can otherwise receive criteria regarding a clinical study and receive data with patient identification (e.g. patients name and birthday, or a patient identification code such as a patient social security number), wherefrom a Patient's ID Database may be built.

The analytical device 200 then may derive rules from the criteria. These rules may include, but are not limited to, rules which help determines threshold(s)/milestone(s) compliance/reward(s)/timeliness/qualitative measures/quantitative measure/protocol requirement(s)/weighting for reward(s), threshold(s), milestone(s)/etc. The rules which may be applied to check results/data from a clinical study for their compliance with the criteria (threshold/milestone/etc.). These rules may be converted (if necessary) by the analytical device 200 into a machine-readable form, which can then be interfaced to and understood by, for example, the clinical workflow management system. Then, the rules may be applied, for example, for all patients with Ids contained in the patient ID data base (corresponding to patients participating within the clinical study); may be applied to check results of patient actions involving these patients for there compliance with the criteria (meeting a threshold/milestone requirement, etc.).

The analytical device 200 is able to access and analyze clinical data, such as that stored in any of the clinical workflow management system 210, EPR 212, HIS 214 (or any other type of clinical IT infrastructure and/or database). This analytical device 200 connects or is otherwise networked to, and can thereby access/receive/obtain and then analyze clinical data of patients participating in a study from any of the clinical workflow management system 210, EPR 212, HIS 214 (or any other type of clinical IT infrastructure and/or database). The analytical device 200 may further be networked or otherwise connected to the sponsor 220, the clinical study SOP database 280 and/or the CRO 230. The analytical device 200 can then receive or otherwise obtain criteria for a clinical study from the sponsor 220, clinical study SOP database 280 and/or CRO 230 and can then analyze the obtained clinical data in conjunction with (or based upon) the obtained criteria (rules/thresholds/milestones/etc.) for a clinical study. The analytical device 200 can further optionally be connected to at least one external device 270 used by the patient (such as a drug dispenser, for example, with a built in sensor, processor and communication module); and/or to an additional storage 260 (for storing points/reward information for patients, for example).

The analytical device 200 of an embodiment of the present application is then able to correlate and/or compare the clinical data collected from at least one clinical trial for the patient to (or based upon) the obtained criteria for a clinical study (at least one threshold, which could be a milestone for example), and can then reward the patient upon the collected data at least meeting the at least one threshold.

Alternatively or in addition thereto, the analytical device 200 is able to collect data and use the compared information to monitor the patients involved in the clinical study for at least one the clinical trial site. Thereafter, the analytical device 200 can determine whether or not the patient has complied with at least one criterion of the clinical trial (such as a milestone, threshold, etc.) and can then indicate that the patient is entitled to compensation upon determining that the patient has complied with at least one criterion of the clinical trial (e.g. has reached a milestone, for example).

Initially, the analytical device 200 obtains criteria for the clinical study, which may include at least one protocol for the clinical study for example. This can be achieved by accessing the clinical study “standard operating procedure” (SOP) information from a database 280, for example. The criteria for the clinical study may be translated into rules which are machine-readable by the clinical workflow management system 210 for example and/or other aspects of the analytical device 200, wherein applicable criteria may be selected from the database 200 using a graphical user interface, for example. Alternatively, the criteria for the clinical study may be automatically translated into rules which are machine-readable by the clinical workflow management system 210 for example, or by other aspects of the analytical device 200 including at least one of a look-up table, a thesaurus, an ontology, etc. Further, the criteria for the clinical study may be translated into rules which are machine-readable, wherein applicable criteria are selected from a database.

As shown in FIG. 2, the analytical device 200 can receive requirements/milestones/thresholds and/or other criteria of the clinical study directly from the sponsor 220, which can include the criteria for the clinical study; directly or indirectly from the clinical study SOP 280; and/or from the CRO 230 managing the study; noting that the CRO 230 may take on all necessary services for managing the study including, but not limited to development of a study protocol, recruiting patients and investigators and/or investigation or trial sites, contracting the participants, supervising the conductance of the study, collecting and evaluating the data and channeling the data from the sponsor to the participants. Thus, the CRO 230, sponsor 200, and/or clinical study SOP 280 may transmit information regarding desired/necessary criteria of the clinical study (and even desired target milestones/thresholds/etc.) to the analytical device 200. Accordingly, the analytical device 200, in some way, obtains access to the information in the clinical study SOP database 280.

Clinical data of a plurality of clinical trial or investigation sites/patients/investigators/etc., and the obtained criteria, may be further analyzed to determine rewards/milestones/thresholds across or using multiple clinical trial or investigation sites, which meet or exceed target/milestone/threshold/etc. compliance with the obtained criteria. As such, plural patients/clinical trial sites/investigators/etc may be ranked accordingly. This ranked information can then be output or otherwise sent to the sponsor 220 and/or CRO 230 for use in determining desired patients/clinical trial sites/investigators/etc. for continued use and/or termination regarding the clinical study.

“Criteria”, as referenced throughout the embodiments of the application, refers to clinical study criteria. These “criteria” are important aspects of the clinical study. These criteria of the study can be used by the analytical device 200. Thus, the criteria outline key or other important aspects (milestones/thresholds/etc. and what is necessary to meet such milestones/thresholds/etc.) of the study which, when provided and correlated/compared with clinical data, can help produce measures of compliance of the clinical study that can be used, for example, to monitor patients of at least one clinical study and even reward or indicate entitlement to compensation.

Some non-limiting examples of “criteria” may include, but are not limited to e.g.:
(a) Keeping an appointment for a scheduled visit. This can be verified either in real time, when a patient shows up or doesn't show up, or retrospectively by analyzing the scheduling system's data or a calendar for example;
(b) Compliance in dosage of medication—e.g. the patient is taking the medication within the agreed time frame according to a defined schedule. This can be verified by using pill dispensers with a logging mechanism, patient diaries, etc;
(c) The patient fills out a quality-of-life questionnaire each time before a visit. This can be verified by checking the completeness of the questionnaire during each visit, for example;
(d) The patient signs the informed consent; etc.

Often, elements relating to these “criteria” cannot be measured directly, but must be deduced from other measurable parameters or clinical data, and perhaps from a combination of other measurable parameters or other measurable clinical data. This may include volatile data which may be entered and/or stored for only a short time, and later deleted or erased. For example, the exact time as to when a patient has taken a drug or eaten his meal is usually not measured and recorded by a nurse. However, this time is typically recorded in the Clinical Workflow Management System when the drug and the meal are scheduled for delivery to the patient. Therefore, the criterion “pre-prandial medication” can at least, to some certainty, be indirectly deduced from the two database entries including “Scheduled time for drug delivery to patient” and “Scheduled time for meal delivery to patient”, provided that the patient has taken medication and is eating meals immediately after delivery.

As such, an attempt may be made to correlate/compare volatile clinical data with criteria for the clinical study. If so, the volatile data may be permanently stored upon determining a correlation and/or a lack of correlation. Also, volatile clinical data may be correlated with criteria for the clinical study, and the volatile data may be permanently stored upon determining that the measure of compliance is at/below/or exceeds a threshold. Further, clinical data may be stored permanently, upon determining that the data relate to a patient enrolled in the clinical study.

Thus, the analytical device 200 can, for example, build an empirical database for use in such situations, which contains rules on how to combine measurable indirect criteria in order to derive from these, a probability that a non-measurable criterion is met. Accordingly, the analytical device 200 can create a type of mathematical formula or weighting factors regarding the combining of several direct and indirect aspects of the criteria into a weighted combination. Most likely, this formula will include a weighted sum or weighted product of a single criteria. This can then be correlated with existing clinical data from the clinical IT infrastructure to derive a measure of compliance and/or to monitor a patient of at least one clinical study for at least one clinical trial site, for example.

In one aspect of one embodiment, information or contracts which regulate the amounts of payment upfront, between the sponsor on one side and the CRO 230, and/or investigator, and/or patient on the other side, may be based on organizational milestones. In the past, the clinical trial business models did not make use of clinical IT infrastructure and databases, such as electronic patient records (EPR 212), hospital information systems (HIS 214) or clinical workflow management systems 210. In an embodiment of the present application, such clinical IT infrastructure and databases, storing various types of clinical data, are utilized in connection with obtained criteria for the clinical study, to derive performance measures of the study, which can then be used to improve the study (and/or the clinical study business process).

Thus, an incentive system may be introduced for all participants in a clinical trial. Such a system can reward and then track earned points, for example “trial points” (that can be used toward rewards). These points, in the form of a reward, can then be stored in EPR 212, additional storage 260, etc. and then accumulated and tracked for greater rewards.

For the patient, the investigator and optionally other stakeholders (this can include, for example: CRA or Clinical Research Associate; this can be a person employed by the study sponsor or CRO to monitor a clinical study at all participating sites; a research/study nurse, who can be the person who assists the investigator in the administrative coordination of the clinical trial; investigator, who can be a person responsible for the conduct of the clinical trial at a trial site. If a trial is conducted by a team of individuals at a trial site, the investigator may be the responsible leader of the team and may be called the principal investigator; sponsor, who can be an individual, company, institution, or organization which takes responsibility for the initiation, management, and/or financing of a clinical trial; site, which can be the location(s) where trial-related activities are actually conducted, etc.) the criteria for the rewarding are defined, e.g. by the sponsor. The reimbursement/incentive model is preferably translated into rewarded abstract currency trial points. A trial points account may be established for each patient to accumulate the points.

Additional criteria for earning trial points can be defined optionally (e.g. a certain amount for each visit of the investigator may results in points for the patient and the investigator). Many of the processes that support a better compliance of the patient and the investigator may be coupled with ‘earning points’. Thus, both the investigator and patient may earn points.

A tool for optimization of a payment scheme may be used, which takes variables like milestone times, percentage of payments per milestone and stakeholder, value of results achievement at each milestone, incurred cost etc. as an input, and automatically calculates a cost/benefit-optimized payment plan. Everyone who is entitled to earn points may further be able to check an account continuously and can preferably cash out and/or receive other benefits (financial investments: shares, funds; gift coupons at stores, etc.)—optionally linked to requirements such as a limit of points, etc. This may be achieved, for example, by analytical device 200 in conjunction with EPR 212, additional storage 260, etc.

“Corporate Currency” may also be used for “volatile” patients or paramedic personal, but is not preferred for Investigators or sites. Additional features of a corporate currency model that might attract patients to enroll and retain in study can include, but are not limited to an option to trade trial points on a market place; patients with a certain number of trial points may be treated like preferred customers and may be offered special treatments or other healthcare services. In order to authorize milestones as passed, a data infrastructure and network as shown in FIG. 2 may be used, which gathers data, makes decisions on milestones and communicates the decision. A helpful tool for automated evaluation of milestones could be that disclosed in German Application “Qualitätsorientierte Bewertung klinischer Studiendaten” (DE102004008197.2, filed Feb. 18, 2004), the entire contents of which are hereby incorporated herein by reference. In the context of quality of the acquired data, the validation may be achieved with the technologies and processes described in the above mentioned German application. Some criteria (see 0028/0029) can be validated utilizing the methods described in the above mentioned German application (e.g. existing IT systems may be used to validate if a patient showed up at the scheduled visit by utilizing the scheduling functionality of the hospital information system).

Milestones may optionally also lead to penalties instead of payments, if defined thresholds are not achieved. A penalty may be subtraction of points, a freeze of an account, total loss of an account, etc. for example.

Various technical infrastructures can be used to communicate the successful accomplishment of a trial process step to the trial points account in addition to, or in conjunction with the structure of FIG. 2. For example, an EDC system could initiate such communication events, or a trial management platform. In the case of paper based trials, the principal investigator could communicate with the points account.

A goal of an embodiment of the present application is to improve the compliance of patients, investigators and optionally other stakeholders in a clinical trial (CRA, etc.) by coupling an incentive system to crucial trial process steps (such as medication taken by the patient, surgery performed on the patient, etc.). This allows a more direct control of each one over the (financial) reimbursement for the participation in the clinical trial. In his model, there is at least one participant paying for the incentives (sponsor) and there are many incentive recipients—ordered by responsibility. These can include, but are not limited to:
Manager of all clinical trial sites; Manager of one clinical trial site; Manager of a department
Investigating physician; and Patient.

The incentives may be paid, for example, only for results presented in a pre-determined time frame. A substantial fraction of the incentives may be held back until the complete trial is finished successfully. Thus, payment milestones (as shown in FIG. 3 for example) may be used. The trial points may further act as a type of special “currency”. These points could, in one embodiment, even be used for possibly non-clinical things such as for shopping (mail order, etc.), shares, funds or other financial investments.

Further, in another embodiment for improving incentives for patients, the method can include a method of monitoring participation of a patient in at least one clinical trial. Such a method can include collecting data regarding at least one clinical trial for the patient; determining, using a computer device such as analytical device 200 for example, whether or not the patient has complied with at least one criterion of the at least one clinical trial, from the collected data; and rewarding the patient upon determining that the patient has complied with at least one criterion of the at least one clinical trial.

Further, in another embodiment for improving incentives for patients, the method can include a method of monitoring participation of a patient in at least one clinical trial. Such a method can include collecting data regarding at least one clinical trial for the patient; determining, using a computer device such as analytical device 200 for example, whether or not the patient has complied with at least one criterion of the at least one clinical trial; and indicating that the patient is entitled to compensation upon determining that the patient has complied with at least one criterion of the at least one clinical trial.

Further, for any of the above-mentioned embodiments, data collection may be enhanced by leveraging the existing communication and data exchange infrastructure (as shown in FIG. 2 for example) in a clinical trial, e.g. by using electronic data capture systems (EDC), patient diaries, specific internet portals, etc. (designated by external device 270 used by the patient shown in FIG. 2, which can transmit information to and/or receive information from analytical device 200). Further, new communication and data exchange infrastructure may be implemented to collect data from the clinical workflow management system 210, the EPR 212, the HIS 214, etc. Additionally, state-of-the-art rules engines or similar algorithms may be used and/or developed to compare/correlate the collected data at least to one threshold. Finally, the patient may be rewarded in many different ways including, but not limited to receiving clinical points (stored and accumulated in an account in EPR 212, additional storage 260, etc.; and/or sent to a patient in a statement; and/or etc.) usable for a variety of services that may be perceived as attractive for this group of persons (patients), e.g. an additional diagnostic procedure that is usually not covered by insurances; a visit to a well recognized physician, discounts on drugs/physician visits/treatments/etc.; a financial benefit; a medical treatment benefit; a medical drug benefit; etc.

In addition, for any of the above-mentioned embodiments, threshold may include any milestone, etc. and can include, but is not limited to, a number of patient visits during a clinical trial, any and/or all activities of a patient in a study that can be influenced by the patient, etc.

In addition, for any of the above-mentioned embodiments, a clinical study may include on in which the patient needs to take a medication periodically. As such, a drug dispenser may be used (shown a external device 270 of FIG. 2 used by the patient, for example) including a built in sensor, processor and communication module for example, to log each pill being taken out and send this information to a central processor to thereby collect data about the patient in the trial. Compliance with clinical study criteria may thus be even further enhanced.

Further, for any of the above-mentioned embodiments, timeliness may be included as a criteria for reaching a threshold/milestone/etc. For example, timeliness can involve comparing the time/date of the patient visits with timelines dictated by the study protocol.

Further, for any of the above-mentioned embodiments, the thresholds/milestones/etc. may be correlated/ranked/weighted by importance of the actions for a clinical trial. It might be crucial to have the second patient visit in a time frame of two days, for example, where otherwise the study protocol would enforce a dropout. Thus, weighting of actions in a clinical study may influence a number of points given/reward given for compliance wherein compliance with certain important criteria of the clinical study may be weighted more heavily and result in more points than compliance with other criteria (which may result in even less or no points, and/or which may results in no points/rewards given for the patient for the entire clinical trial).

One non-limiting example of an embodiment of the present application is shown in FIG. 3. A patient is recruited for a pharmaceutical trial—a new medication for disease x. When enrolled into the study by the investigator the patient receives n points at milestone 1. This is credited to the patient's trial account (i.e. enrolling in a study may be the first threshold reached and may result in a reward, noting that such an enrollment reward may be lost if other criteria, such as showing up for the first day of a study for example, are not met).

After showing up in time at the second visit, the patient is credited with more points at milestone 2 (reaching a next threshold or milestone as defined by the study). Thereafter, by reaching other thresholds, such as by showing the investigator the completed patient diary (completed between first and second visit), the patient may then be credited with more points.

After the second visit, the patient may need to take a medication regularly until the third visit. A drug dispenser with a built-in sensor and processor may be used to detect a date of removal of a drug and may stores this information. At the third visit, the drug dispenser (connected to the analytical device 200 for example) may then be used such to retrieve information (e.g. the analytical device 200 may read the time stamps from the drug dispenser and compare this with the clinical trial protocol that defines what amount of medication needs to be taken, and when). Again points may then be further credited to the patient account at milestone 3 if every removal of a drug was timely (if this additional conditional threshold/milestone was met). At the end of the study, the patient receives n points for finishing it at milestone n. The points can be accumulated, stored in EPR 212/additional storage 260/etc. and can traded in for incentives, etc.

The assignee of the present application has further been involved in various other inventions regarding clinical studies, and in some cases the use of clinical IT infrastructure, in order to improve the development of clinical study business models and/or the development of clinical study protocols; improving the effectiveness of patient recruiting; controlling the compliance of clinical study protocol rules; etc. The entire contents of each of the following applications is hereby incorporated by reference in the present application:
“Procedure to Identify Eligible Study Patients in an All-Day Setting” (U.S. provisional application Ser. No. 60/545,169, filed Feb. 18, 2004) and corresponding U.S. non-provisional application entitled “A Method Of Recruiting Patients For A Clinical Study”, assigned U.S. application Ser. No. ______, and filed on Oct. 28, 2004;
“Incentive-System for Clinical Trials” (U.S. provisional application Ser. No. 60/545,170, filed Feb. 18, 2004), and corresponding U.S. non-provisional application entitled “A Method Of Monitoring Patient Participation In A Clinical Study”, assigned U.S. application Ser. No. ______, and filed on Oct. 28, 2004;
“Procedure Providing a Benchmarking of Clinical Test Sites and a Concomitant Method of Quality-Based Monetary Compensation”; (U.S. provisional application Ser. No. 60/545,165, filed Feb. 18, 2004) and corresponding U.S. non-provisional application entitled “A Method Of Examining A Plurality Of Sites for A Clinical Trial”, assigned U.S. application Ser. No. ______, and filed on Oct. 28, 2004;
“Risk-Sharing Business Model for the Use of HIS Data to Improve Cost Effectiveness of Clinical Studies” (U.S. provisional application Ser. No. 60/545,168, filed Feb. 18, 2004) and corresponding U.S. non-provisional application entitled “A Method Of Improving A Clinical Study”, assigned U.S. application Ser. No. ______, and filed on Oct. 28, 2004;
“Quality Compliance Improvement in Clinical Studies using IT-Based Clinical Workflow Systems” (U.S. provisional application Ser. No. 60/545,164, filed Feb. 18, 2004) and corresponding U.S. non-provisional application entitled “Method and System For Measuring Quality of Performance and/or Compliance with Protocol of a Clinical Study”, assigned U.S. application Ser. No. ______, and filed on Oct. 28, 2004;
Verfahren zur Durchführung einer klinischen Studie (DE 10 2004 008 196.4);
Verfahren zur Überprüfung der Durchführbarkeit eines medizinischen Vorhabens mit Aufnahmekriterien für Patienten (DE 10 2004 008 189.1);
Verfahren zur Qualitätskontrolle von je an unterschiedlichen, aber vergleichbaren Patientenkollektiven im Rahmen eines medizinischen Vorhabens erhobenen medizinischen Datensätzen (DE 10 2004 008 197.2);
Verfahren und Einrichtung zur Überprüfung der Einhaltung einer Durchführungsvorschrift für eine an einem Patienten durchgeführte medizinische Maβnahme (DE 10 2004 008 190.5);
Verfahren zur Qualitätsbewertung von elektronisch gespeicherten, insbesondere medizinischen, Wissensdaten (DE 10 2004 008 191.3);
Verfahren zur Auswahl eines moglichen Teilnehmers für ein medizinisches Vorhaben anhand eines Auswahlkriteriums (DE 10 2004 008 192.1);
Verfahren und Informationssystem zur Durchführung einer klinischen Studie an einem Patienten. (DE 10 2004 008 194.8);
Verfahren zur Überprüfung der Einhaltung einer einem medizinischen Arbeitsablauf zugeordneten Durchführungsvorschrift (DE 10 2004 008 195.6); and
Verfahren zur Auswahl eines Teilnehmers für ein medizinisches Vorhaben mit Auswahlkriterien für Patienten (DE 10 2004 008 188.3).

Thus, it should be understood that FIG. 2, and each of the figures and embodiments of the present application, represents the analytical 200 with access to the clinical workflow management system 210, an EPR 212 and/or an HIS 214 of one, or of a plurality of clinical trial sites; as well as access to one or a plurality of additional storage devices 260 and one or a plurality of external devices 270. Thus, the clinical data can include data from a plurality of clinical trial sites, and further can include data from a plurality of previously conducted clinical trials. Clinical data from a plurality of clinical trial sites may thereby be further analyzed in conjunction with, or compared to the obtained criteria for a clinical study.

Each of the various embodiments discussed above can include the use of weighting factors. For example, the clinical study criteria obtained can include weighing factors, wherein the weighting factors may reflect a likelihood of the “criteria” to correlate with direct benefit, such as a financial benefit to someone/something, for example. The rewarding/indicating entitlement of compensation may be based upon one or more weighting factors. With regard to clinical study criteria such as study duration, costs, study result reliability, major “criteria” which may help to influence these measures positively may include, but are not limited to:
Overall number of patients which can be enrolled in the study, respectively number of patients per time unit which can be enrolled;
Time-effectiveness of data collection and evaluation;
Compliance of investigator and patient with the study rules;
Experience/capability of the investigator to motivate patients for continued participation until the end of the study, and not drop out earlier;
Claimed amount of compensation from investigator and patient, etc.

Often, these “criteria” cannot be measured directly, but must be deduced from other measurable parameters, and perhaps from a combination of other measurable parameters. Thus, the analytical device 200 may, for example, build an empirical database on typical “dropout” rates of patients, wherein these rates might vary with investigation sites, patient's age, geography, etc. Thus, the analytical device 200 can create a type of mathematical formula or weighting factors regarding the combining of several direct and indirect criteria into a prediction of probable benefit, such as probable financial benefit to the sponsor/investigator/etc. Most likely, this formula will include a weighted sum or weighted product of the single criteria. Accordingly, an output reward may be derived based upon weighted determinations using the weighing factors.

Any of the aforementioned embodiments described in the form of methods may be embodied in the form of a system or device, including, but not limited to, any of the structure for performing the methodology illustrated in the drawings. In one embodiment, an apparatus for monitoring participation of a patient in at least one clinical trial can include at least one device for collecting data regarding at least one clinical trial for the patient from an external device and for comparing the collected data to at least one threshold. Further, it can include a device for rewarding the patient upon the collected data at least meeting at least one threshold.

Still further, in yet another embodiment, an apparatus for monitoring participation of a patient in at least one clinical trial can include at least one device for collecting data regarding at least one clinical trial for the patient from at least one external device and for determining whether or not the patient has complied with at least one criterion of the at least one clinical trial, from the collected data. Further, it can include a device for rewarding the patient upon determining that the patient has complied with at least one criterion of the at least one clinical trial.

Finally, in still another embodiment, an apparatus for monitoring participation of a patient in at least one clinical trial can include at least one device for collecting data regarding at least one clinical trial for the patient from at least one external device and for determining whether or not the patient has complied with at least one criterion of the at least one clinical trial. Further, it can include a device for indicating that the patient is entitled to compensation upon determining that the patient has complied with at least one criterion of the at least one clinical trial.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method of monitoring participation of a patient in at least one clinical trial, comprising:
collecting data regarding at least one clinical trial for the patient;
comparing, using a computer device, the collected data to at least one threshold; and
rewarding the patient upon the collected data at least meeting at least one threshold.

2. The method of claim 1, wherein the collected data is compared to a plurality of thresholds and wherein the patient is rewarded each time the collected data exceeds one of the plurality of thresholds.

3. The method of claim 2, wherein the at least one threshold is determined based upon criteria of the at least one clinical trial.

4. The method of claim 1, wherein the at least one threshold is determined based upon criteria of the at least one clinical trial.

5. The method of claim 1, wherein the comparing of the collected data to a threshold relates to compliance, by the patient, of at least one criterion of the at least one clinical trial.

6. The method of claim 5, wherein the at least one criterion includes timeliness.

7. The method of claim 5, wherein the at least one criterion includes at least one qualitative measure.

8. The method of claim 5, wherein the at least one criterion includes at least one quantitative measure.

9. The method of claim 5, wherein the at least one criterion includes at least one protocol requirement of the at least one clinical trial.

10. The method of claim 1, wherein the plurality of thresholds are weighted and wherein the rewarded is weighted relative to the threshold.

11. The method of claim 1, wherein the rewarding includes rewarding points.

12. The method of claim 11, wherein the points are redeemable for at least one of a financial benefit, a medical treatment benefit, a medical drug benefit, an additional diagnostic procedure not normally covered by insurances, a visit to a physician, and a discount.

13. The method of claim 10, wherein the rewarding includes rewarding points.

14. The method of claim 13, wherein the points are redeemable for at least one of a financial benefit, a medical treatment benefit, a medical drug benefit, an additional diagnostic procedure not normally covered by insurances, a visit to a physician, and a discount.

15. The method of claim 1, wherein the method further includes penalizing upon the collected data failing to meet at least at least one threshold.

16. The method of claim 11, wherein the method further includes penalizing upon the collected data failing to meet at least at least one threshold.

17. The method of claim 16, wherein the penalizing includes a reduction in points.

18. The method of claim 11, wherein the points are stored in a storage device.

19. The method of claim 13, wherein the points are stored in a storage device.

20. The method of claim 17, wherein the points are stored in a storage device.

21. The method of claim 1, wherein the data is collected from at least one external database.

22. The method of claim 1, wherein the data is collected from at least one external device used by the patient.

23. The method of claim 21, wherein the data is collected from at least one external device used by the patient.

24. A method of monitoring participation of a patient in at least one clinical trial, comprising:
collecting data regarding at least one clinical trial for the patient;
determining, using a computer device, whether or not the patient has complied with at least one criterion of the at least one clinical trial, from the collected data; and
rewarding the patient upon determining that the patient has complied with at least one criterion of the at least one clinical trial.

25. The method of claim 24, wherein the at least one criterion includes timeliness.

26. The method of claim 24, wherein the at least one criterion includes at least one qualitative measure.

27. The method of claim 24, wherein the at least one criterion includes at least one quantitative measure.

28. The method of claim 24, wherein the at least one criterion includes at least one protocol requirement of the at least one clinical trial.

29. The method of claim 24, wherein the collected data is compared to a plurality of criteria and wherein the patient is rewarded each time it is determined that the patient has complied with one of the plurality of criteria.

30. The method of claim 29, wherein the plurality of criteria are weighted and wherein the rewarded is weighted relative to the criterion.

31. The method of claim 24, wherein the rewarding includes rewarding points.

32. The method of claim 31, wherein the points are redeemable for at least one of a financial benefit, a medical treatment benefit, a medical drug benefit, an additional diagnostic procedure not normally covered by insurances, a visit to a physician, and a discount.

33. The method of claim 30, wherein the rewarding includes rewarding points.

34. The method of claim 33, wherein the points are redeemable for at least one of a financial benefit, a medical treatment benefit, a medical drug benefit, an additional diagnostic procedure not normally covered by insurances, a visit to a physician, and a discount.

35. The method of claim 24, wherein the method further includes penalizing upon the collected data failing to meet at least at least one threshold.

36. The method of claim 31, wherein the method further includes penalizing upon determining that the patient has failed to comply with the at least one criterion of the clinical trial.

37. The method of claim 36, wherein the penalizing includes a reduction in points.

38. The method of claim 31, wherein the points are stored in a storage device.

39. The method of claim 33, wherein the points are stored in a storage device.

40. The method of claim 37, wherein the points are stored in a storage device.

41. The method of claim 24, wherein the data is collected from at least one external database.

42. The method of claim 24, wherein the data is collected from at least one external device used by the patient.

43. The method of claim 41, wherein the data is collected from at least one external device used by the patient.

44. A method of monitoring participation of a patient in at least one clinical trial, comprising:
collecting data regarding at least one clinical trial for the patient;
determining, using a computer device, whether or not the patient has complied with at least one criterion of the at least one clinical trial; and
indicating that the patient is entitled to compensation upon determining that the patient has complied with at least one criterion of the at least one clinical trial.

45. The method of claim 44, wherein the at least one criterion includes timeliness.

46. The method of claim 44, wherein the at least one criterion includes at least one qualitative measure.

47. The method of claim 44, wherein the at least one criterion includes at least one quantitative measure.

48. The method of claim 44, wherein the at least one criterion includes at least one protocol requirement of the at least one clinical trial.

49. The method of claim 44, wherein the determination is made for compliance of a plurality of criteria and wherein it is indicated that the patient is entitled to compensation each time it is determined that the patient has complied with one of the plurality of criteria.

50. The method of claim 49, wherein the plurality of criteria are weighted and wherein the compensation is weighted relative to the criterion.

51. The method of claim 44, wherein the indicating includes awarding points.

52. The method of claim 51, wherein the points are redeemable for at least one of a financial benefit, a medical treatment benefit, a medical drug benefit, an additional diagnostic procedure not normally covered by insurances, a visit to a physician, and a discount.

53. The method of claim 50, wherein the indicating includes awarding points.

54. The method of claim 53, wherein the points are redeemable for at least one of a financial benefit, a medical treatment benefit, a medical drug benefit, an additional diagnostic procedure not normally covered by insurances, a visit to a physician, and a discount.

55. The method of claim 44, wherein the method further includes penalizing upon the collected data failing to meet at least at least one threshold.

56. The method of claim 51, wherein the method further includes penalizing upon determining that the patient has failed to comply with the at least one criterion of the clinical trial.

57. The method of claim 56, wherein the penalizing includes a reduction in points.

58. The method of claim 51, wherein the points are stored in a storage device.

59. The method of claim 53, wherein the points are stored in a storage device.

60. The method of claim 57, wherein the points are stored in a storage device.

61. The method of claim 44, wherein the data is collected from at least one external database.

62. The method of claim 44, wherein the data is collected from at least one external device used by the patient.

63. The method of claim 61, wherein the data is collected from at least one external device used by the patient.

64. The method of claim 1, wherein the collected data is stored in a memory.

65. The method of claim 1, wherein the comparing further includes comparing the collected data to at least one threshold of acceptability.

66. The method of claim 5, wherein the criteria includes quality and performance parameters.

67. A device for implementing the method of claim 1.

68. A device for implementing the method of claim 24.

69. A device for implementing the method of claim 44.

70. A program, adapted to perform the method of claim 1, when executed on a computer device.

71. A computer readable medium, storing the program of claim 70.

72. A program, adapted to perform the method of claim 24, when executed on a computer device.

73. A computer readable medium, storing the program of claim 72.

74. A program, adapted to perform the method of claim 44, when executed on a computer device.

75. A computer readable medium, storing the program of claim 75.

76. An apparatus for monitoring participation of a patient in at least one clinical trial, comprising:
means for collecting data regarding at least one clinical trial for the patient from an external device;
means for comparing the collected data to at least one threshold; and
means for rewarding the patient upon the collected data at least meeting at least one threshold.

77. The apparatus of claim 76, wherein the collected data is compared to a plurality of thresholds and wherein the patient is rewarded each time the collected data exceeds one of the plurality of thresholds.

78. The apparatus of claim 76, wherein the at least one threshold is determined based upon criteria of the at least one clinical trial.

79. The apparatus of claim 76, wherein the comparing of the collected data to a threshold relates to compliance, by the patient, of at least one criterion of the at least one clinical trial.

80. The apparatus of claim 77, wherein the plurality of thresholds are weighted and wherein the rewarded is weighted relative to the threshold.

81. The apparatus of claim 76, wherein the rewarding includes rewarding points.

82. The apparatus of claim 81, wherein the points are stored in a storage device.

83. The apparatus of claim 76, wherein the at least one external device includes at least one of at least one external database and at least one external device used by the patient.

84. An apparatus for monitoring participation of a patient in at least one clinical trial, comprising:
means for collecting data regarding at least one clinical trial for the patient from at least one external device;
means for determining whether or not the patient has complied with at least one criterion of the at least one clinical trial, from the collected data; and
means for rewarding the patient upon determining that the patient has complied with at least one criterion of the at least one clinical trial.

85. The apparatus of claim 84, wherein the collected data is compared to a plurality of thresholds and wherein the patient is rewarded each time the collected data exceeds one of the plurality of thresholds.

86. The apparatus of claim 84, wherein the at least one threshold is determined based upon criteria of the at least one clinical trial.

87. The apparatus of claim 84, wherein the comparing of the collected data to a threshold relates to compliance, by the patient, of at least one criterion of the at least one clinical trial.

88. The apparatus of claim 85, wherein the plurality of thresholds are weighted and wherein the rewarded is weighted relative to the threshold.

89. The apparatus of claim 84, wherein the rewarding includes rewarding points.

90. The apparatus of claim 89, wherein the points are stored in a storage device.

91. The apparatus of claim 84, wherein the at least one external device includes at least one of at least one external database and at least one external device used by the patient.

92. An apparatus for monitoring participation of a patient in at least one clinical trial, comprising:
means for collecting data regarding at least one clinical trial for the patient from at least one external device;
means for determining whether or not the patient has complied with at least one criterion of the at least one clinical trial; and
means for indicating that the patient is entitled to compensation upon determining that the patient has complied with at least one criterion of the at least one clinical trial.

93. The apparatus of claim 92, wherein the collected data is compared to a plurality of thresholds and wherein the patient is rewarded each time the collected data exceeds one of the plurality of thresholds.

94. The apparatus of claim 93, wherein the plurality of thresholds are determined based upon criteria of the at least one clinical trial.

95. The apparatus of claim 93, wherein the plurality of thresholds are weighted and wherein the rewarded is weighted relative to the threshold.

96. The apparatus of claim 92, wherein the indicating includes rewarding points.

97. The apparatus of claim 96, wherein the points are stored in a storage device.

98. The apparatus of claim 92, wherein the at least one external device includes at least one of at least one external database and at least one external device used by the patient.
